(19) United States
(12) Patent Application Publication
(10) Pub. No.: US 2016/0203838 A1
(43) Pub. Date: Jul. 14, 2016

(54) DISK DRIVE, CONTROL METHOD THEREOF, AND DRIVER IC

(71) Applicant: Kabushiki Kaisha Toshiba, Tokyo (JP)

(72) Inventor: Yu Chen, Sagamihara Kanagawa (JP)

(21) Appl. No.: 14/656,527

(22) Filed: Mar. 12, 2015

Related U.S. Application Data
(60) Provisional application No. 62/102,191, filed on Jan. 12, 2015.

(51) Int. Cl. G11B 5/55; G11B 27/36; G11B 5/012

(52) U.S. Cl. CPC G11B 5/5526; G11B 5/012; G11B 27/36

(57) ABSTRACT

According to one embodiment, a disk drive is disclosed. The drive includes a motor which rotates a magnetic disk, an actuator which moves a head provided for the magnetic disk, and a driver circuit which drives the motor and the actuator. The driver circuit includes a storage circuit in which data relating to operation is stored, a monitor circuit to output a first signal to the storage circuit based on a result of monitoring an internal voltage, and an interrupt circuit to interrupt input of the first signal from the monitor circuit to the storage circuit in response to a second signal input from outside the driver circuit.

### CROSS-REFERENCE TO RELATED APPLICATIONS

This application claims the benefit of U.S. Provisional Application No. 62/102,191, filed Jan. 12, 2015, the entire contents of which are incorporated herein by reference.

### FIELD

Embodiments described herein relate generally to a disk drive, a control method thereof, and a driver IC.

### BACKGROUND

In recent years, a printed circuit board of a magnetic disk apparatus includes a driver IC in which drivers are integrated on a single chip. The drivers include a spindle motor driver and a voice coil motor driver. When a current greater than or equal to a particular value flows through the driver IC or is output from the driver IC, the driver IC stops operation.

### BRIEF DESCRIPTION OF THE DRAWINGS

FIG. 1 is an illustration schematically showing a configuration of a magnetic disk apparatus according to a first embodiment;

FIG. 2 is an illustration schematically showing a configuration of a driver IC of the first embodiment;

FIG. 3 is a flowchart showing a diagnosis method of the driver IC of the first embodiment;

FIG. 4 is an illustration for explaining a modification of the driver IC of the first embodiment;

FIG. 5 is an illustration schematically showing a configuration of a driver IC of a magnetic disk apparatus according to a second embodiment; and

FIG. 6 is a flowchart showing a diagnosis method of the driver IC of the second embodiment.

### DETAILED DESCRIPTION

Embodiments will be described hereinafter with reference to the accompanying drawings. In the following figures, portions corresponding to the previously shown portions are denoted by the same reference numerals and omitted its detail explanation.

In general, according to one embodiment, a disk drive is disclosed. The drive includes a motor which rotates a magnetic disk, an actuator which moves a head provided for the magnetic disk, and a driver circuit which drives the motor and the actuator. The driver circuit includes a storage circuit in which data relating to operation is stored, a monitor circuit to output a first signal to the storage circuit based on a result of monitoring an internal voltage, and an interrupt circuit to interrupt input of the first signal from the monitor circuit to the storage circuit in response to a second signal input from outside the driver circuit.

### First Embodiment

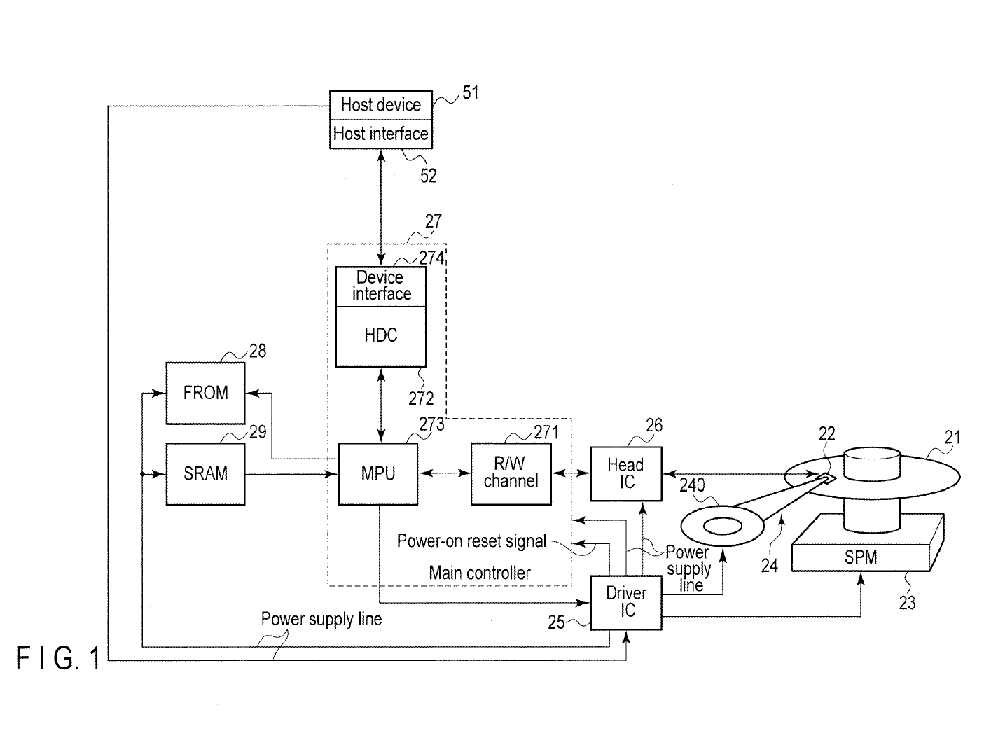

FIG. 1 is an illustration schematically showing a configuration of a magnetic disk apparatus according to a first embodiment.

The magnetic disk apparatus of the present embodiment includes a magnetic disk 21, a head 22, a spindle motor (SPM) 23, an actuator 24, a driver IC 25, a head IC 26, a main controller 27, and memories (a flash ROM (FROM) 28, an SRAM 29).

The magnetic disk 21 comprises a recording surface on which data is magnetically recorded, for example, on one side. The magnetic disk 21 is rotated by the SPM 23. The SPM 23 is driven by a current (or a voltage) supplied from the driver IC 25. The recording surface of the magnetic disk 21 comprises tracks arranged in a concentric circle or a spiral.

The head (head slider) 22 is disposed corresponding to the recording surface of the magnetic disk 21. The head 22 is attached to a tip of a suspension extending from an arm of the actuator 24. The actuator 24 comprises a voice coil motor (VCM) 240 serving as a driving source of the actuator 24. The VON 240 is driven by a current (or a voltage) supplied from the driver IC 25. The actuator 24 is driven by the VCM 240, whereby the head 22 moves over the magnetic disk 21 to make a circular arc in a radial direction of the magnetic disk 21.

Although FIG. 1 shows the configuration in which the one magnetic disk 21 is provided, a plurality of magnetic disks 21 may be provided. In addition, although in FIG. 1, the magnetic disk 21 comprises the recording surface on one side, the magnetic disk 21 may comprise recording surfaces on both sides, and heads may be disposed corresponding to both the recording surfaces, respectively.

The driver IC 25 drives the SPM 23 and the VCM 240 under the control of the main controller 27. The VCM 240 is driven by the driver IC 25, whereby the head 22 is positioned at a target track on the magnetic disk 21.

The head IC 26 is disposed at a position separated from the actuator 24 in FIG. 1, but is, for example, fixed to a particular part of the actuator 24 and is electrically connected to the main controller 27 through a flexible printed circuit (FPC) board. The head IC 26 amplifies a read signal read by a read element of the head 22. In addition, the head IC 26 converts write data supplied from the main controller 27 into a write current and outputs the write current to a write element of the head 22.

The main controller 27 is structured, for example, as a system LSI (system on a chip [SOC]) in which elements are integrated on a single chip. The main controller (SOC) 27 includes a read/write (R/W) channel 271, a hard disk controller (HDC) 272, and an MPU 273.

The R/W channel 271 processes a signal related to reading/writing. That is, the R/W channel 271 converts a read signal amplified by the head IC 26 into digital data, and decodes read data from the digital data. In addition, the R/W channel 271 encodes write data supplied from the HDC 272, and transfers the encoded write data to the head IC 26.

The HDC 272 is electrically connected to a host interface (host IF) 52 of a host device 51 through a device interface (device IF) 274. The device IF 274 receives a signal transferred from the host device 51, and transfers the signal to the host device 51. More specifically, the HDC 272 receives an access command (a write command, a read command, etc.) transferred from the host device 51, and transfers the received command to the MPU 273. The HDC 272 controls data transfer between the host device 51 and the HDC 272. The HDC 272 also functions as a disk interface controller which controls writing to the magnet disk 21 and reading from the magnetic disk 21 through the MPU 273, the R/W channel 271, the head IC 26, and the head 22.

The MPU 273 controls access to the magnetic disk 21 through the R/W channel 271, the head IC 26 and the head 22 in response to an access command (a write command or a read command) from the host device 51. A control program (firmware) executed by the MPU 273 is stored in the FROM 28 or the magnetic disk 21. A part of a storage area of the SRAM 29 is used as a work area of the MPU 273.

The driver IC 25 converts power from the host device 51 into a particular voltage, and supplies it to the SOC 27, the FROM 28, the SRAM 29, the driver IC 25 and the head IC 26. Moreover, when power is supplied, the driver IC 25 supplies a power-on reset signal to the SOC 27.

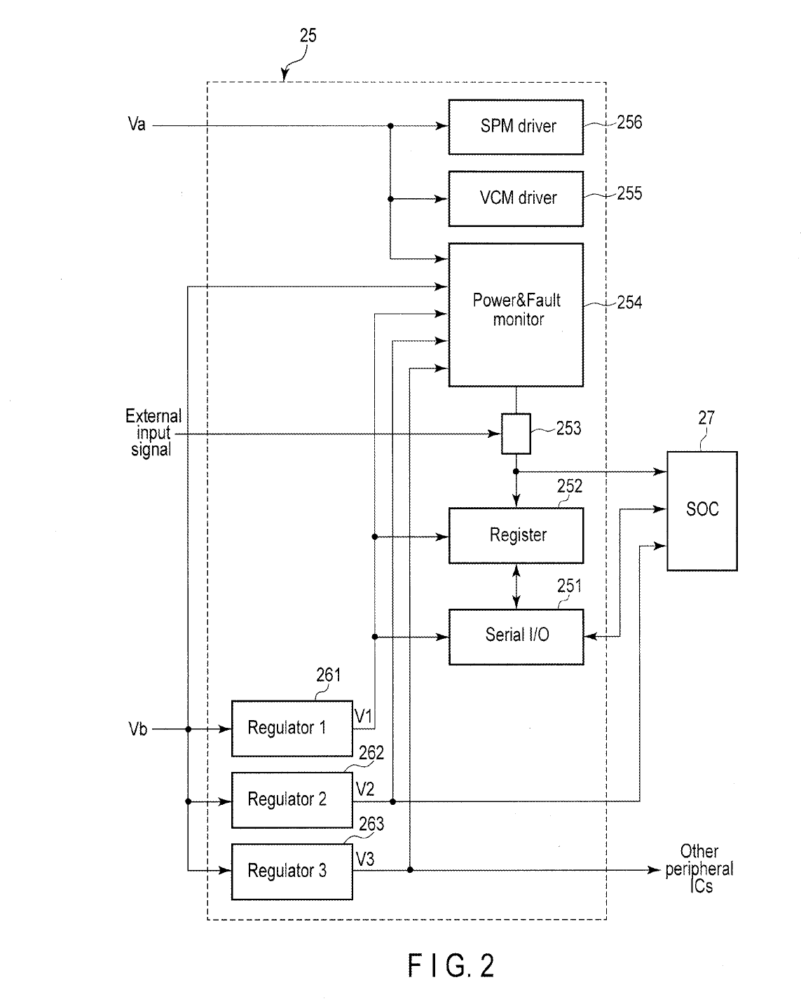

FIG. 2 is an illustration schematically showing a configuration of the driver IC 25.

The driver IC 25 includes circuits, for example, a serial I/O block 251, a register circuit 252, a breaker 253, a power and fault monitor block (hereinafter, simply referred to as a monitor block) 254, a VCM driver block 255, a SPM driver block 256, and regulator blocks 261 to 263.

The serial I/O block 251 is connected to the register circuit 252 and the SOC 27. Serial communication is performed between the SOC 27 and the serial I/O block 251. The SOC 27 can write data to the register circuit 252 through the serial I/O block 251 by serial communication. In addition, the SOC 27 can read data stored in the register circuit 252 through the serial I/O block 251 by serial communication.

The breaker 253 is provided between the register circuit 252 and the monitor block 254. The breaker 253 blocks input of a signal from the monitor block 254 to the register circuit 252 in response to an external input signal inputted from outside the driver IC 25.

In addition, the breaker 253 blocks input of a signal from the monitor block 254 to the SOC 27 in response to the external input signal. Signals transmitted from the monitor block 254 to the register circuit 252 and the SOC 27 includes a reset signal. The breaker 253 includes a switch for turning on or off connection between the register circuit 252 and the monitor block 254 and connection between the SOC 27 and the monitor block 254. The monitor block 254 monitors various kinds of power in the driver IC 25.

A voltage Va is supplied to the VCM driver block 255 and the SPM driver block 256 from a host which is outside the driver IC 25. The voltage Va is used as a power supply voltage to operate the VCM driver block 255 and the SPM driver block 256. The voltage Va is, for example, 12V. In addition, the voltage Va is also input to the monitor block 254, and the monitor block 254 monitors the input voltage Va. A result of the monitoring is stored in the register circuit 252. The monitor block 254 outputs a reset signal to the register circuit 252 and the SOC 27, when an abnormality in the voltage Va is detected, for example, when the voltage Va is less than or equal to a particular value. This is intended to immediately stop the operation of the magnetic disk apparatus by outputting a reset signal in order to prevent the main body of the magnetic disk apparatus and stored data from being damaged by an abnormality in a power supply, etc.

In addition, a voltage Vb is applied to the monitor block 254 and the regulator blocks 261 to 263 from a power supply on a host side which is outside the driver IC 25. The voltage Vb is monitored by the monitor block 254. The voltage Vb is, for example, 5V.

The regulator block 261 generates a voltage V1 on the basis of the voltage Vb. The voltage V1 is used as a power supply voltage to operate the serial I/O block 251, the register circuit 252, and the monitor block 254. Further, the monitor block 254 monitors the input voltage V1. A result of the monitoring is stored in the register circuit 252. The monitor block 254 output a reset signal to the register circuit 252 and the SOC 27, when an abnormality in the voltage V1 is detected, for example, when the voltage V1 is less than or equal to a particular value.

The regulator block 262 generates a voltage V2 on the basis of the voltage Vb. The voltage V2 is used as a power supply voltage to operate the SOC 27. Further, the voltage V2 is input to the monitor block 254, and the monitor block 254 monitors the input voltage V2. A result of the monitoring is stored in the register circuit 252. The monitor block 254 outputs a reset signal to the register circuit 252 and the SOC 27, when an abnormality in the voltage V2 is detected, for example, when the voltage V2 is less than or equal to a particular value.

The regulator block 263 generates a voltage V3 on the basis of the voltage Vb. The voltage V3 is used as a power supply voltage to operate other peripheral ICs (for example, the head IC 26). Further, the voltage V3 is input to the monitor block 254, and the monitor block 254 monitors the input voltage V3. A result of the monitoring is stored in the register circuit 252. The monitor block 254 outputs a reset signal to the register circuit 252 and the SOC 27, when an abnormality in the voltage V3 is detected, for example, when the voltage V3 is less than or equal to a particular value.

The VCM driver block 255 and the SPM driver block 256 are connected to the serial I/O block 251 and the register circuit 252 through an interconnect not shown in the figure. The SOC 27 controls the VCM driver block 255 and the SPM driver block 256 through the serial I/O block 251 and the register circuit 252.

In the register circuit 252, data relating to operation for the VCM driver block 255 and the SPM driver block 256 is stored. The VCM driver block 255 and the SPM driver block 256 drive the VCM 240 and the SPM 23, respectively, on the basis of the above data.

The register circuit 252 includes a volatile memory and a nonvolatile memory. The nonvolatile memory is, for example, an electrically erasable and programmable ROM (EEPROM). Data stored in the nonvolatile memory is held even when power to the nonvolatile memory is interrupted. Data relating to operation for the VCM driver block 255 and the SPM driver block 256 is stored in the volatile memory. A result of monitoring may be stored in the nonvolatile memory.

In the above-described example, the register circuit 252 includes the volatile memory and the nonvolatile memory, but may not include the nonvolatile memory. In this case, a result of monitoring is also stored in the volatile memory. When a reset signal is input to the register circuit 252, data stored in the volatile memory is initialized. That is, the register circuit 252 initializes stored data in response to input of a reset signal.

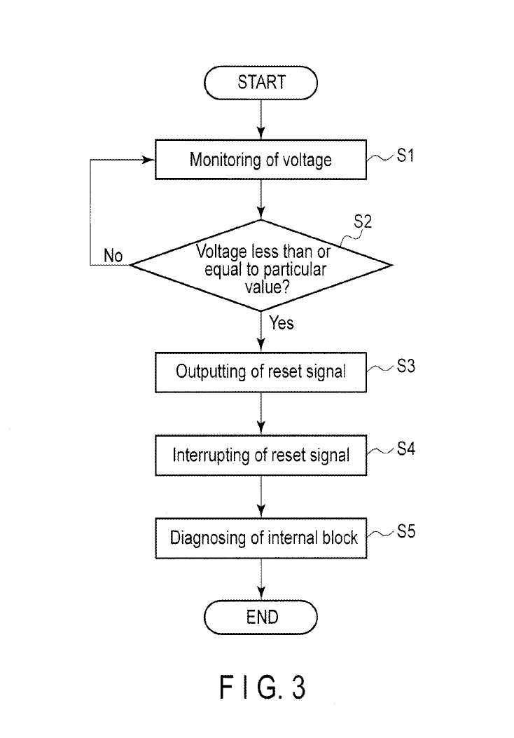

FIG. 3 is a flowchart showing a control method of the magnetic disk apparatus of the present embodiment.

[Step S1]

After a power supply of the magnetic disk apparatus is turned on, the monitor block 254 monitors the voltage Va, the voltage Vb, the voltage V1, the voltage V2, and the voltage V3. A configuration which monitors some of the voltages Va, V1, V2 and V3 may be adopted.

[Step S2]

The monitor block 254 determines whether at least one of the voltage Va, the voltage Vb, the voltage V1, the voltage V2, and the voltage V3, which are being monitored, is less than or equal to a particular value. In step S2, when the voltages exceed the particular value (No), the flow returns to step S1.

[Step S3]

In step S2, when at least one of the voltages is less than or equal to the particular value (Yes), the monitor block 254 outputs reset signals to the register circuit 252 and the SOC 27. When a reset signal is input to the register circuit 252, some items of data stored in the register circuit 252 is initialized to prevent an IC malfunction, etc. The items of data include, for example, data relating to operation for the VCM driver block 255 and the SPM driver block 256. When a reset signal is input to the SOC 27, the SOC 27 stops operation. In addition, the operation of the driver IC 25 is also stopped. When the driver IC 25 is stopped, the VCM driver block 255 and the SPM driver block 256 stop driving the SPM 23 and the actuator 24, respectively.

[Step S4]

The power supply of the magnetic disk apparatus is turned on, and an external input signal is input to the breaker 253 of the driver IC 25. When the external input signal is inputted to the breaker 253, the input of reset signals from the monitor block 254 to the register circuit 252 and the SOC 27 is blocked.

In the state where the input of a reset signal is blocked, the register circuit 252 is not initialized and data relating to operation can be written. Further, in the state where the input of a reset signal is blocked, the SOC 27 can control the register circuit 252, the VCM driver block 255, the SPM driver block 256, and the regulator blocks 261 to 263 through the serial I/O block 251.

Here, if the input of a reset signal is not blocked, the register circuit 252 is immediately reset by the monitor block 254. Thus, data which has been written to the register circuit 252 for carrying out diagnoses of the blocks 255, 256, and 261 to 263 is initialized, whereby it is hard to carry out the diagnoses.

[Step S5]

Thereafter, the diagnosis of blocks in the driver IC 25 is carried out. For example, the diagnosis of the VCM driver block 255 is carried out in the following manner.

The SOC 27 writes data (VCM data) on operation for the VCM driver block 255 in the register circuit 252 through the serial I/O block 251. The VCM data includes, for example, a current value to be passed through the VCM 240.

Under the control of the SOC 27, the VCM data written in the register circuit 252 is inputted to the VCM driver block 255 through the serial I/O block 251. The VCM driver block 255 outputs a current or a voltage to drive the VCM 240 on the basis of the inputted VCM data.

When the VCM 240 is driven in accordance with operation corresponding to the VCM data, the VCM driver block 255 is diagnosed as normal. On the other hand, when the VCM 240 does not operate in accordance with the above operation, the VCM driver block 255 or the VCM 240 is diagnosed as abnormal. For example, when the VCM 240 does not operate, it is determined that the VCM driver block 255 may be damaged by an overvoltage or an overcurrent. Further, even when the VCM 240 operates, the VCM driver block 255 is diagnosed as abnormal when the actuator 24 is not driven as desired.

In addition, the diagnosis of the SPM driver block 256 is carried out in the following manner.

The SOC 27 writes data (SPM data) relating to operation for the SPM driver block 256 in the register circuit 252 through the serial I/O block 251. The SPM data includes, for example, the rotational speed of the SPM 23.

Under the control of the SOC 27, the SPM data written in the register circuit 252 is inputted to the SPM driver block 256 through the serial I/O block 251. The SPM driver block 256 outputs a current or a voltage to drive the SPM 23 on the basis of the inputted SPM data.

When the SPM 23 is driven in accordance with operation corresponding to the SPM data, the SPM driver block 256 is diagnosed as normal. On the other hand, if the SPM 23 does not operate in accordance with the above operation, the SPM driver block 256 or the SPM 23 is diagnosed as abnormal. For example, when the SPM 23 does not operate, it is determined that the SPM driver block 256 may be damaged by an overvoltage or an overcurrent. Further, even when the SPM 23 operates, the SPM driver block 256 is diagnosed as abnormal when the magnetic disk does not rotate at a desired speed.

As described above, according to the present embodiment, at the time of the diagnosis of the driver IC 25, the input of a reset signal from the monitor block 254 to the register circuit 252 can be blocked by the breaker 253, so that the VCM data and SPM data written in the register circuit 252 can be prevented from being initialized. The VCM driver block 255 thereby can drive the VCM 240 on the basis of written VCM data. Therefore, the VCM driver block 255 can be diagnosed by examining whether the VCM 240 performs an operation corresponding to VCM data. Similarly, the SPM driver block 256 can drive the SPM 23 on the basis of written SPM data. Therefore, the SPM driver block 256 can be diagnosed by examining whether the SPM 23 performs an operation corresponding to SPM data.

In addition, the monitor block 254 monitors a voltage in the present embodiment, but may monitor a current, and moreover, may monitor a voltage and a current.

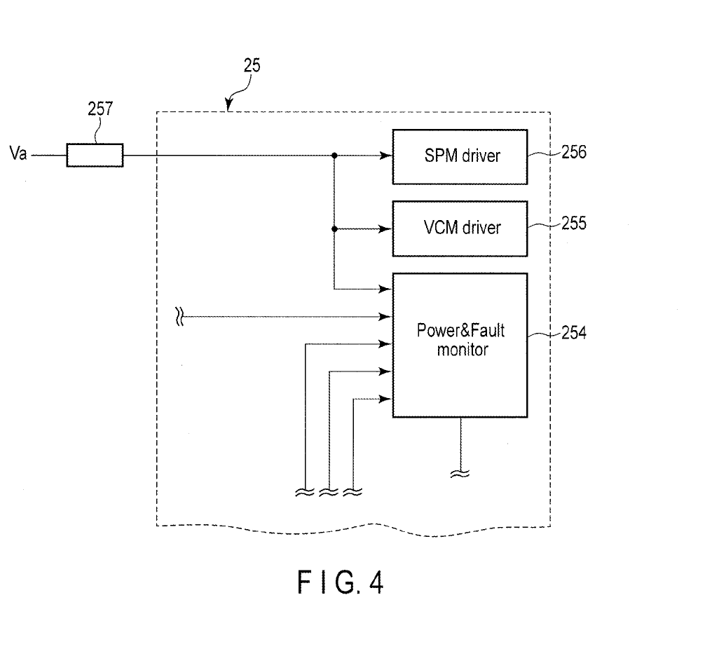

Furthermore, as shown in FIG. 4, a fuse 257 (peripheral component of the driver IC 25) may be provided on a PCB outside the driver IC 25.

The voltage Va is applied to the monitor block 254, the VCM driver block 255, and the SPM driver block 256 through the fuse 257. When the fuse 257 blows because of an abnormality, the voltage Va is not applied to the monitor block 254, the VCM driver block 255, and the SPM driver block 256.

Therefore, if the monitor block 254 detects that the voltage Va is not normally input, it is determined that an abnormality may occur in peripheral components of the driver IC 25 (for example, cutting of the fuse 257).

Similarly, a configuration in which the voltage Vb is applied to the monitor block 254 through a fuse on a PCB not shown in the figure may be adopted.

### Second Embodiment

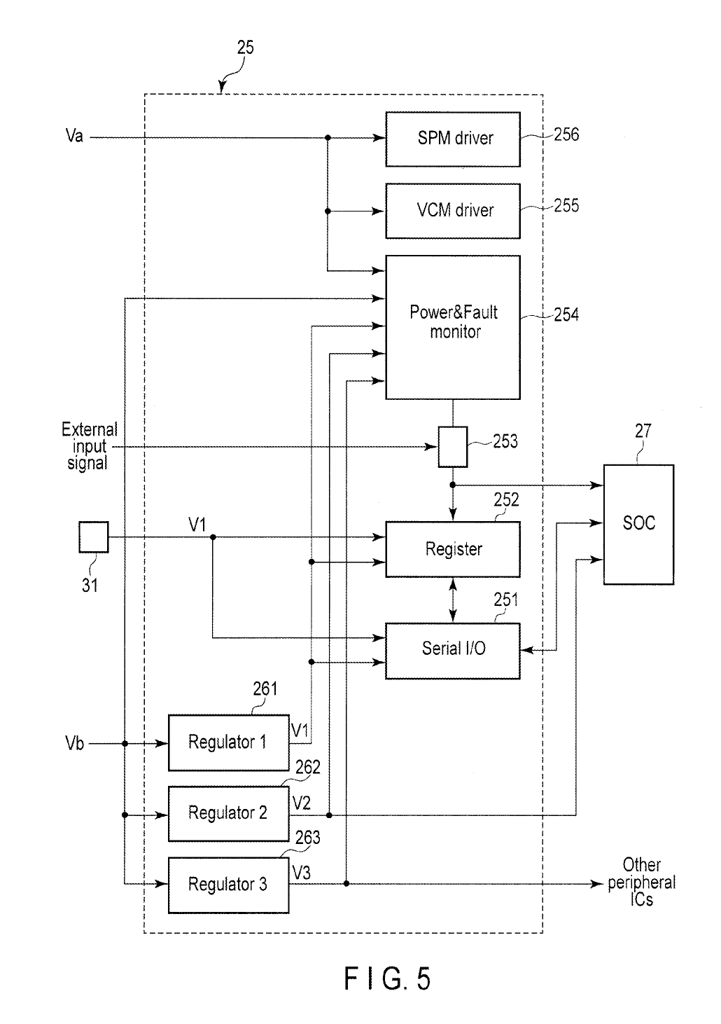

FIG. 5 is an illustration schematically showing a configuration of a driver IC 25 of a magnetic disk apparatus according to a second embodiment.

The driver IC 25 of the present embodiment differs from that of the first embodiment in that it can be connected to an external power supply 31 other than a bower supply on a host side. In FIG. 5, a serial I/O block 251 and a register circuit 252 of the driver IC 25 can be connected to the external power supply 31. A regulator block 261 generates a voltage V1 on the basis of a voltage Vb supplied from the power supply on the host side. When the power supply on the host side is abnormal, the voltage Vb may not be supplied to the regulator block 261, and it is not possible for the regulator block 261 to generate the voltage V1. As a result, the voltage V1 is not applied to the serial I/O block 251 and the register circuit 252, and the serial I/O block 251 and the register circuit 252 do not operate normally.

Thus, in the present embodiment, at the time of the diagnosis of the driver IC 25, the serial I/O block 251 and the register circuit 252 are connected to the external power supply 31, and the voltage V1 is applied to the serial I/O block 251 and the register circuit 252 from the external power supply 31. It can be thereby determined whether a problem exists in the driver IC 25 or the power supply on the host side.

For example, when a problem exists in those other than the serial I/O block 251 and the register circuit 252, the driver IC 25 does not operate normally even when the voltage V1 is applied to the serial I/O block 251 and the register circuit 252 from the external power supply 31. On the other hand, when a problem exists in the power supply on the host side, the driver IC 25 operates normally, because the voltage V1 is applied to the serial I/O block 251 and the register circuit 252 from the external power supply 31. In addition, because the state of the monitor block 254 at the time of occurrence of the abnormality can be checked through the register circuit 252, it can be easily determined what kind of abnormality has occurred.

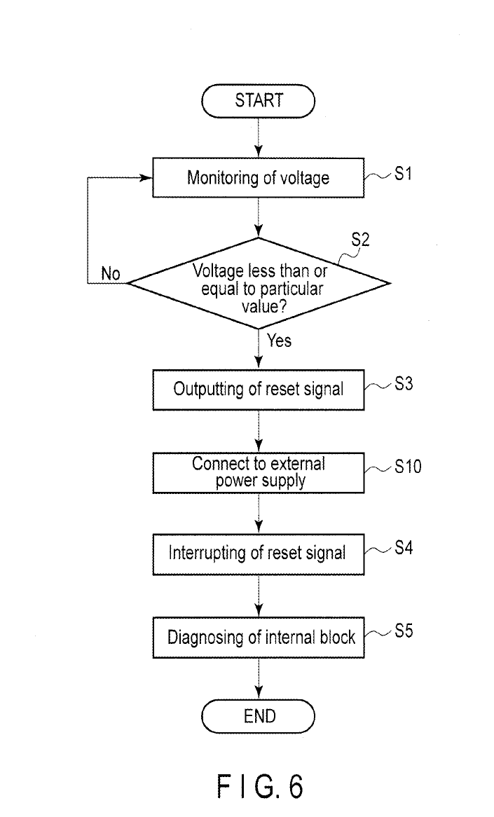

FIG. 6 is a flowchart showing a control method of the magnetic disk apparatus of the present embodiment.

The control method of the present embodiment differs from that of the first embodiment in that step S10 is carried out between step S3 and step S4. In step S10, the serial I/O block 251 and the register circuit 252 are connected to the external power supply 31. For example, a terminal of the external power supply 31 is connected to a pad on a printed circuit board of the magnetic disk apparatus. The pad is connected to the serial I/O block 251 and the register circuit 252.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk drive comprising:
a motor which rotates a magnetic disk; an actuator which moves a head provided for the magnetic disk; and
a driver circuit which drives the motor and the actuator,
the driver circuit comprising:
a storage circuit in which data relating to operation is stored;
a monitor circuit to output a first signal to the storage circuit based on a result of monitoring an internal voltage; and
an interrupt circuit to interrupt input of the first signal from the monitor circuit to the storage circuit in response to a second signal input from outside the driver circuit.

2. The drive of claim 1, wherein the driver circuit further comprises a first circuit which drives the motor; and a second circuit which drives the actuator, and
wherein the monitor circuit monitors a voltage supplied to the first or second circuit, and outputs the first signal in response to detection of an abnormality of the monitored voltage.

3. The drive of claim 1, wherein the driver circuit further comprises a first circuit which drives the motor; and a second circuit which drives the actuator, and
wherein the first and second circuits stop driving the motor and the actuator in response to output of the first signal by the monitor circuit.

4. The drive of claim 1, wherein the storage circuit initializes the data in response to input of the first signal from the monitor circuit.

5. The drive of claim 1, wherein the storage circuit comprises a nonvolatile memory in which stored data is held even when power is interrupted.

6. The drive of claim 1, wherein the storage circuit is adapted to be supplied with power from outside instead of the internal voltage.

7. A control method of a disk drive comprising a motor; an actuator; and a driver circuit to drive the motor and the actuator,
the driver circuit comprising:
a storage circuit in which data relating to operation is stored; and
a monitor circuit to output a first signal to the storage circuit based on a result of monitoring an internal voltage, and
the method comprising:
inputting a second signal to the driver circuit from outside the driver circuit; and
interrupting input of the first signal from the monitor circuit to the storage circuit in response to input of the second signal.

8. The method of claim 7, wherein the driver circuit further comprises a first circuit which drives the motor; and a second circuit which drives the actuator, and
the method further comprises monitoring a voltage supplied to the first or second circuit and outputting the first signal in response to detection of an abnormality of the monitored voltage.

9. The method of claim 7, wherein the driver circuit further comprises a first circuit which drives the motor; and a second circuit which drives the actuator, and
the method further comprises stopping the first and second circuits from driving the motor and the actuator in response to output of the first signal by the monitor circuit.

10. The method of claim 7, further comprising:
writing data in the storage circuit after interrupting the input of the first signal, the data relating to operation of a drive circuit which drives the motor or the actuator; and
diagnosing the drive circuit based on operation of the motor or the actuator according to the written data.

11. The method of claim 7, further comprising:
connecting the storage circuit to an external power supply instead of the internal voltage after interrupting the input of the first signal;
writing data in the storage circuit after connecting to the external power supply, the data relating to operation of a drive circuit which drives the motor or the actuator; and
diagnosing the drive circuit based on operation of the motor or the actuator according to the written data.

12. A driver IC comprising a drive circuit to drive a driving target to be connected,
the drive circuit comprising:
a storage circuit in which data relating to operation is stored;
a monitor circuit to output a first signal to the storage circuit based on a result of monitoring an internal voltage; an
an interrupt circuit to interrupt input of the first signal from the monitor circuit to the storage circuit in response to a second signal input from outside the driver circuit.

13. The IC of claim 12, wherein the monitor circuit monitors a voltage supplied to the drive circuit, and outputs the first signal in response to detection of an abnormality of the monitored voltage.

14. The IC of claim 12, wherein the drive circuit stops driving the driving target in response to output of the first signal by the monitor circuit.

15. The IC of claim 12, wherein the storage circuit initializes the data in response to input of the first signal from the monitor circuit.

16. The IC of claim 12, wherein the storage circuit comprises a nonvolatile memory in which stored data is held even when power is interrupted.

17. The IC of claim 12, wherein the storage circuit is adapted to be supplied with power from outside instead of the internal voltage.
